(19) United States
(12) Patent Application Publication
(10) Pub. No.: US 2008/0303727 A1
(43) Pub. Date: Dec. 11, 2008

(54) UNDERCARRIAGE FITTED WITH A COMMUNICATION DEVICE BETWEEN A WHEEL AND THE UNDERCARRIAGE

(75) Inventors: Jean-Clair PRADIER, Houilles (FR); Bertrand MAES, Issy Les Moulineaux (FR)

Correspondence Address: SUGHRUE MION, PLLC, 2100 PENNSYLVANIA AVENUE, N.W., SUITE 800, WASHINGTON, DC, 20037, US

(73) Assignee: MESSIER-BUGATTI, Velizy Villacoublay (FR)

(21) Appl. No.: 12/132,787

(22) Filed: Jun. 4, 2008

(30) Foreign Application Priority Data
Jun. 7, 2007 (FR) 07 04088

(51) Int. Cl. H01Q 1/28

(52) U.S. Cl. 343/708

(57) ABSTRACT

The invention relates to an aircraft undercarriage including at least one axle having at least one wheel mounted to rotate thereon, the undercarriage including a communication device for connecting a sensor mounted on a rim of the wheel to stationary processing means mounted on the aircraft, the communication device comprising a rotary antenna mounted on the wheel rim to rotate therewith and connected to the sensor, and a stationary antenna facing said rotary antenna so that the antennae are in electromagnetic relation, said stationary antenna being connected to the processing means, wherein the stationary antenna and the rotary antenna extend on the inner side of the wheel facing the undercarriage.

The invention relates to a communication device between a sensor mounted on an aircraft wheel and stationary processing means mounted on the aircraft.

### BACKGROUND OF THE INVENTION

In aviation, it is common practice to monitor tire pressures continuously by means of a pressure sensor disposed on the rim of the wheel. The sensor is connected to a first antenna that rotates with the wheel, this antenna extending facing a stationary antenna carried at the end of the wheel axle and connected to processing means for processing information from the sensor via electrical connections that extend inside the axle. Thus, when the wheel is removed, there is no need to disconnect the sensor of the processing means. Nevertheless, a communication device as disposed in that way is relatively exposed, and can suffer damage, e.g. in the event of an impact against an external obstacle.

### OBJECT OF THE INVENTION

An object of the invention is to provide a particular arrangement for the communication device, enabling it to be better protected.

### BRIEF SUMMARY OF THE INVENTION

According to the invention, there is provided an aircraft undercarriage including at least one axle having at least one wheel mounted to rotate thereon, the undercarriage including a communication device for connecting a sensor mounted on a rim of the wheel to stationary processing means mounted on the aircraft, the communication device comprising a rotary antenna mounted on the wheel rim to rotate therewith and connected to the sensor, and a stationary antenna facing said rotary antenna so that the antennae are in electromagnetic relation, said stationary antenna being connected to the processing means, wherein the stationary antenna and the rotary antenna extend on the inner side of the wheel facing the undercarriage

Thus, the communication device is entirely hidden from the outside, thereby protecting it against potential impacts. In addition, the stationary antenna is no longer connected to the processing means by long electrical connections extending inside the axle, but can be connected via short electrical connections passing outside the axle, thereby making it simpler to connect the stationary antenna.

In addition, when placed in this way it serves to release the end of the axle, which can then receive a member enabling the aircraft to be towed.

### BRIEF DESCRIPTION OF THE DRAWINGS

The invention can be better understood in the light of the following description given with reference to the figures of the accompanying drawings, in which:

FIG. 1 is a fragmentary section view of the bottom end of an aircraft nose undercarriage provided with a communication system of the invention, with only the right wheel being shown in section; and

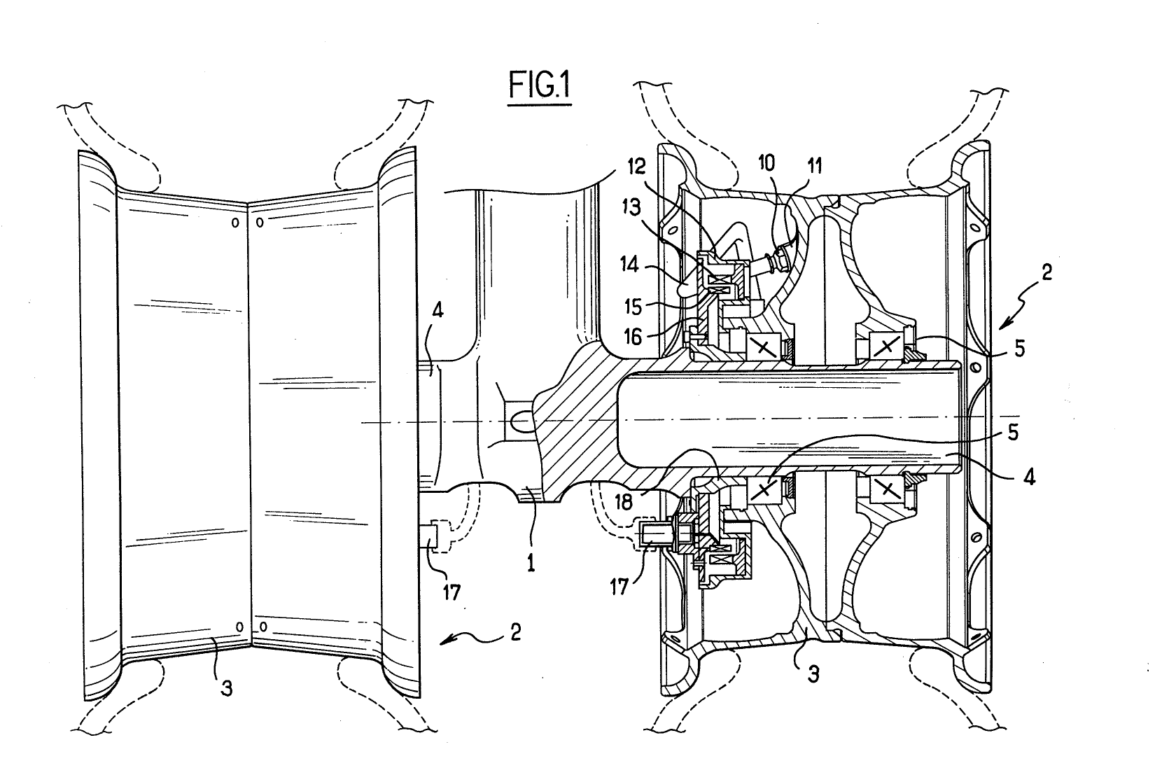

FIG. 2 is a fragmentary perspective view of the undercarriage shown in FIG. 1, the right wheel being omitted.

### DETAILED DESCRIPTION OF THE INVENTION

The figures show the bottom portion of a leg of an airplane nosewheel undercarriage 1 carrying two wheels 2 that do not include brakes. The wheels 2 comprise rims 3 each made up in conventional manner by two juxtaposed half-rims, and their tires are represented by dashed lines.

The rims 3 are received on axles extending from either side of the undercarriage 1, and they are mounted to rotate thereon via bearings 5. For each wheel 2, it is possible to define an inner side facing the undercarriage 1, and an outer side that is visible. It should be observed that the wheels 2 carried by the nosewheel undercarriage 1 do not have any brakes.

Each of the rims 3 is fitted with a pressure sensor 10 that is implanted in a tapped orifice formed in a projection 11, the orifice being in communication with the inside of the tire. The sensor is thus in a position to measure the pressure inside the tire.

Each of the rims 3 has fastened thereon a first support 12 carrying a rotary first antenna 13 that rotates together with the wheel 2. The pressure sensor 10 is readily connected to the rotary first antenna 13 by a connection cable 14. Facing the rotary first antenna 13 there extends a stationary second antenna 15 carried by a second support 16 that is stationary and fitted on the axle 4. The stationary second antenna 15 is connected to a stationary connector 17 carried by the stationary second support 16.

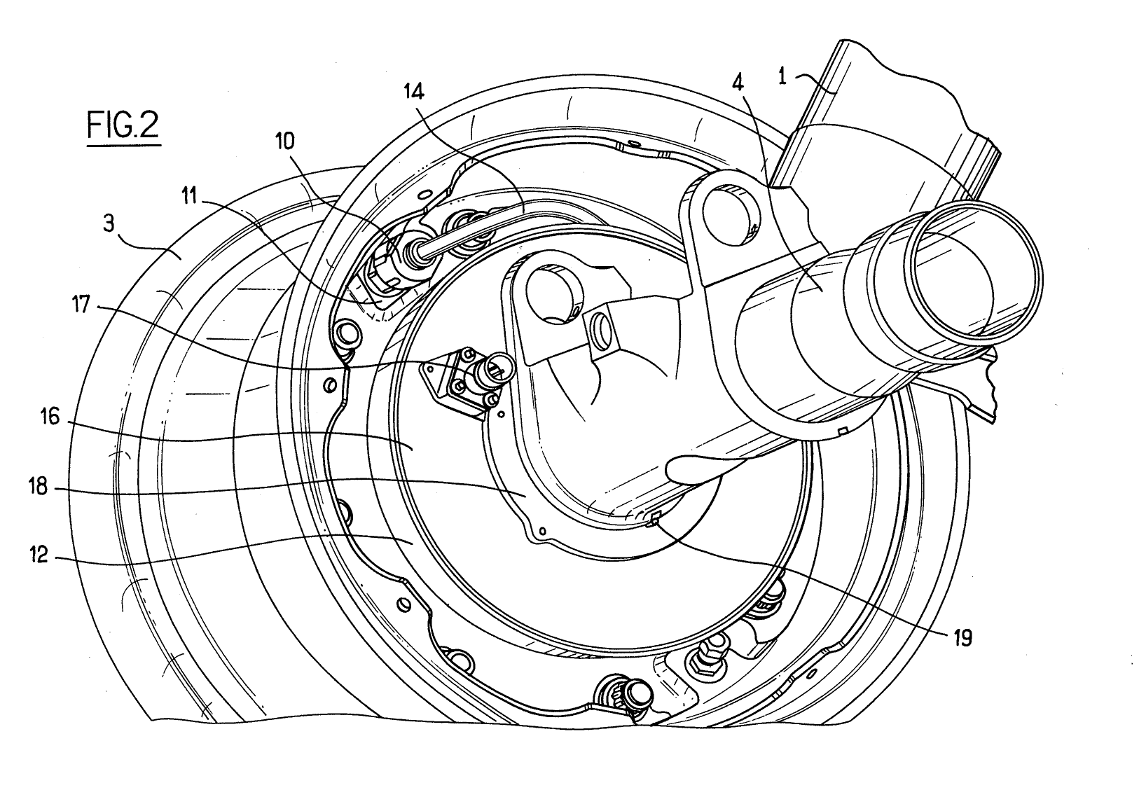

The stationary support 16 is screwed onto a ring 18 that also forms an axial abutment for one of the bearings of the wheel. As can be seen more particularly in FIG. 2, the ring 18 is prevented from rotating by a finger 19 that penetrates into a notch in the axle 4.

The two antennas shown are circular and they are centered on the axis of the wheel. They extend facing each other so that they are into electromagnetic relation, both naturally lying outside the axle.

According to the invention, the rotary antenna 13 is carried by the wheel 2 on the inner side thereof, that faces the undercarriage. The stationary antenna 15, facing the rotary antenna 13, thus extends likewise on the inner side of the wheel 2. Furthermore, the pressure sensor 10 is also installed on the inner side of the wheel 2. All these items are housed inside the rim 3. The only projection beyond the rim 3 is constituted by the end of the connector 17, as can be seen particularly clearly on the left-hand rim which is not in section.

The connector 17 placed in this way is particularly close to the undercarriage 1, thus making it possible to connect a cable thereto that extends down along the undercarriage and that is connected to processing means (not shown) for processing the information delivered by the pressure sensor 10. This cable is represented by dashed lines and therefore does not pass along the inside of the axle 4. This disposition makes it considerably easier to connect the cable, enabling a shorter cable to be used and also avoiding any need to make any hole through which the axle opens out into the inside of the bottom portion of the leg of the undercarriage 1. Thanks to the electromagnetic relation between the rotary antenna 13 and the stationary antenna 15, pressure information measured by pressure sensor 10 is delivered to the processing nears.

The wheels carried by the known undercarriage do not have brakes, so the rim is completely disengaged on its inner side, thus making it possible for it to receive the communication device of the invention.

It can be seen in the figures that such a disposition leaves the ends of the axles completely free, thus enabling them to receive a member for towing the aircraft.

The invention is not limited to the above description, but on the contrary covers any variant coming within the ambit defined by the claims.

What is claimed is:

1. An aircraft undercarriage including at least one axle having at least one wheel mounted to rotate thereon, the undercarriage including a communication device for connecting a sensor mounted on a rim of the wheel to stationary processing means mounted on the aircraft, the communication device comprising a rotary antenna mounted on the wheel rim to rotate therewith and connected to the sensor, and a stationary antenna facing said rotary antenna so that the antennas are in electromagnetic relation, said stationary antenna being connected to the processing means, wherein the stationary antenna and the rotary antenna extend on the inner side of the wheel facing the undercarriage.

2. An undercarriage according to claim 1, in which the communication device is housed substantially entirely inside the rim of the wheel.

3. An undercarriage according to claim 1, in which the rotary antenna and the stationary antenna are circular antennas centered on an axis of rotation of the wheel and extending facing each other.
